(19) United States
(12) Patent Application Publication
(10) Pub. No.: US 2004/0064584 A1
(43) Pub. Date: Apr. 1, 2004

(54) Apparatus and methods of assisting in NAT traversal

(76) Inventors: Julian Mitchell, Maidenhead (GB); George Bouleros, Bracknell (GB)

Correspondence Address: William M. Lee, Jr., Lee, Mann, Smith,, McWilliams, Sweeney & Ohlson, P.O. Box 2786, Chicago, IL, 60690-2786, US

(21) Appl. No.: 10/259,338

(22) Filed: Sep. 27, 2002

(51) Int. Cl. G06F 15/16

(52) U.S. Cl. 709/245

(57) ABSTRACT

To create and maintain a NAT bind, data packets need to flow from a private network to the public network, therefore the device in the private network that will use the NAT bind has to send data packets. This is not always convenient, and the device may not send data packets frequently enough. The invention provides methods for creating, maintaining and discovering NAT binds, and a dedicated device therefor called an Internet Protocol faker that sends packets through the NAT, whereby the source fields of the packets have been edited to be the IP address and port of the real device. When the packets are received by the NAT and their headers analysed, the NAT is fooled into determining that the packets are being sent by the real device, thereby allowing the IP faker to open a NAT bind and maintain the NAT bind on behalf of the real device.

### FIELD OF THE INVENTION

The present invention relates to apparatus and methods of assisting in Network Address Translation (NAT) traversal, and more particularly, to methods of discovering NAT type and bind, to methods of opening and maintaining NAT binds and to a device used therefor.

### BACKGROUND OF THE INVENTION

Network Address Translators (NATs) are used to interconnect a private network consisting of unregistered IP addresses with a global IP network using limited number of registered IP addresses. NATs are also used to avoid address renumbering in a private network when topology outside the private network changes for variety of reasons, such as customers changing Service Providers, company backbones being reorganized, or Service Providers merging or splitting. In addition, there are many other applications of NAT operation.

Basic Network Address Translation or Basic NAT is a method by which IP addresses are mapped from one group to another, transparent to end users. Network Address Port Translation, or NAPT is a method by which many network addresses and their Transmission Control Protocol/User Datagram Protocol (TCP/UDP) ports are translated into a single network address and its TCP/UDP ports. Together, both these operations are referred to as traditional NAT.

Unless mentioned otherwise, the term NAT, as used in this specification, will pertain to traditional NAT, namely basic NAT as well as NAPT, and to the devices performing these functions: Network Address Translators, and Network Address and Port Translators.

NATs require packets flowing from the inside (private network) to the outside (public network), to create a NAT bind and to maintain the NAT bind. NAT binds are specific to a single source address (and sometimes port). This means that in order to create a NAT bind the actual device which will use the bind (referred to in this specification as the real device) has to send data packets. However, this is not always convenient because, for example, the real device is not sending data packets at this stage, or the device is not going to send data packets frequently enough, as in the case of a voice over Internet Protocol (VOIP) gateway with silence suppression and no comfort noise packets, or with one way speech path, or which is on hold. Although NAT binds can be statically provisioned, using such a method lacks flexibility and requires a lot of provisioning.

NAT bind discovery can be done through the use of a protocol such as Simple Traversal of UDP through NATs (STUN). STUN is an IETF Protocol, defined in the IETF draft “http://www.jdrosen. net/papers/draft-ietf-midicom-stun-00.txt”, that allows applications to discover the presence and types of NATs in a network, as well as discovering the actual NAPT bind used for a particular media flow. However, using STUN requires the real device to support STUN and the use of new network components (STUN clients and servers). It also requires some work to be done on the Media Gateways (MGs) or in the networks containing the MGs.

NAT bind discovery can also be done through the use of a media proxy, but this requires additional packet forwarding hardware, and does not work for one-way traffic.

Thus there is a need for devising methods of discovering and maintaining NAT binds for a real device, without requiring any new network elements, or any new protocols or protocol extensions, without requiring any work on the MGs or NATS, and that will work with existing deployments.

The present invention aims to address the needs or at least mitigate the problems identified above.

### SUMMARY OF THE INVENTION

The invention proposes techniques for creating, maintaining, and discovering NAT binds for a real device, as well as a dedicated device to handle the creation and maintenance of NAT bind for a real device - called an Internet Protocol faker (IP faker). By placing this dedicated device on the boundary between the private network of the real device and the public network, it can also identify the NAT type, and for certain NAT types discover the public address and port of the NAT bind, which it is not possible to do directly on the real device if it is entirely in the private realm, and which is not desirable to do indirectly as that is not the primary purpose of the real device. The invention proposes a technique that involves the IP faker sending packets through the NAT, whereby the source fields of the packets have been edited to be the IP address and port of the real device. When the packets are received by the NAT and their headers analysed, the NAT is fooled into determining that the packets are being sent by the real device, thereby allowing the IP faker to open a NAT bind and maintain the NAT bind on behalf of the real device.

Accordingly in a first aspect of the invention there is provided a method of opening a NAT bind for the private Internet Protocol address and port of a real device, said real device having a private Internet Protocol address and port, said method comprising: placing the private Internet Protocol address and port of the real device in source fields of an Internet Protocol header of a data packet of a different device; and sending said data packet through a NAT.

According to a second aspect there is provided a method of maintaining a NAT bind for a real device in a private network, said real device having a private Internet Protocol address and port, said method comprising at predetermined time intervals: editing a data packet having an Internet Protocol header comprising source fields by altering its source fields to comprise the private Internet Protocol address and port of a real device; and sending the edited data packets from a private interface of an Internet Protocol faker through a NAT, wherein said time intervals are predetermined to be smaller than the timeout period set for the NAT.

According to a third aspect of the invention there is provided a method of discovering NAT bind for a real device in a private network, comprising: sending a data packet with faked source fields in its IP headers from a private interface to a public interface of an Internet Protocol faker through a NAT; and analysing the source fields of the data packet received at the public interface of the Internet Protocol faker from the NAT to determine the NAT bind.

According to a fourth aspect of the invention there is provided a method of discovering a Cone NAT bind for a real device in a private network said real device having a private Internet Protocol address and port, said method comprising: editing a data packet having an Internet Protocol header comprising source fields by altering the source fields to comprise the private Internet Protocol address and port of the real device; sending the edited data packet from a private interface to a public interface of the Internet Protocol faker through a Cone NAT; receiving the edited data packet at the NAT from the Internet Protocol faker; reading the source fields of the edited data packet; opening a NAT bind for the private Internet Protocol address and port of the real device; forwarding the data packet to the public interface of the Internet Protocol faker; reading the source fields of the data packet received at the public interface of the Internet Protocol faker; and extracting a public Internet Protocol address and port assigned to the real device to determine the Cone NAT bind.

According to a fifth aspect of the invention there is provided a method of opening a NAT bind for a real device in a communications system comprising a signalling device and an Internet Protocol faker locatable in a signalling path of the signalling device and in parallel with a Cone NAT, said method comprising: receiving a communication initiation message from an external device; allocating the signalling device to handle the message; editing a data packet by altering its source fields to comprise a private Internet Protocol address and port of the selected signalling device; sending the edited data packet from a private to a public interface of the Internet Protocol faker, through the Cone NAT; analysing the source fields of the data packet received at the public interface of the Internet Protocol faker to determine a public Internet Protocol address of the Cone NAT bind; and sending a redirection message with the public Internet Protocol address of the NAT bind to the external device.

According to a sixth aspect of the invention there is provided an Internet Protocol faker having a private interface and a public interface, and operable to: edit a data packet by altering its source fields to comprise a private Internet Protocol address and port of a real device in a private network that said Internet Protocol faker is impersonating; and send the edited data packet from its private interface to its public interface through a Cone NAT.

According to a seventh aspect of the invention there is provided a communications system comprising: an Internet Protocol faker locatable on the boundary of a private and a public network and in parallel with a Cone NAT, said Internet Protocol faker having a private interface and a public interface, and operable to: edit a data packet by altering its source fields to comprise a private Internet Protocol address and port of a real device in a private network that said Internet Protocol faker is impersonating; and send the edited data packet from its private interface to its public interface through the Cone NAT.

According to an eighth aspect of the invention there is provided an Internet Protocol faker having a private and a public interface, and operable to: receive a command to establish a NAT bind for a real device from a Network Element; edit a data packet by altering its source fields to comprise a private Internet Protocol address and port of the real device; send the edited data packet from its private interface to its public interface through a Cone NAT, said Cone NAT creating a NAT bind for the data packet; analyse the source fields of the data packet received at its public interface from the NAT to determine a public Internet Protocol address of the NAT bind; and send a reply to the Network Element with the public Internet Protocol Address of the NAT bind.

According to ninth aspect of the invention there is provided an Internet Protocol faker having a private and a public interface, and operable to: receive a communication initiation message from an external device; allocate a signalling device to handle the message; edit a data packet by altering its source fields to comprise a private Internet Protocol address and port of the signalling device; send the edited data packet from its private interface to its public interface through a Cone NAT, said NAT creating a NAT bind for the data packet; analyse the source fields of the data packet received at its public interface from the NAT to determine a public Internet Protocol address of the NAT bind; and send a redirection message with the public Internet Protocol address of the NAT bind to the external device.

According to an tenth aspect of the invention there is provided a communications system comprising: a signalling device, and an Internet Protocol faker locatable in a signalling path of the signalling device and in parallel with a Cone NAT, said NAT operable to create a NAT bind for a data packet, said Internet Protocol faker having a private and a public interface and operable to: receive a communication initiation message; allocate the signalling device to handle the message; edit a data packet by altering its source fields to comprise a private Internet Protocol address and port of the signalling device; send the edited data packet from its private interface to its public interface through the NAT; analyse the source fields of the data packet received at its public interface from the NAT to determine a public Internet Protocol address of the NAT bind; and send a redirection message with the public Internet Protocol address of the NAT bind.

According to an eleventh aspect of the invention there is provided a communications system comprising: an Internet Protocol faker locatable in a private network, said Internet Protocol faker having a private interface, and operable to: edit a data packet by altering its source fields to comprise the Internet Protocol address and port of a real device in a private network that said Internet Protocol faker is impersonating; and send the edited data packet from its private interface through a NAT.

According to a twelfth aspect of the invention there is provided a communications system comprising: an Internet Protocol faker locatable in a private network, said Internet Protocol faker having a private interface, and operable to: edit a data packet by altering its source fields to comprise the Internet Protocol address and port of a real device in a private network that said Internet Protocol faker is impersonating; and send the edited data packet from its private interface through a NAT.

According to a thirteenth aspect of the invention there is provided a computer program for use in a computer for opening a NAT bind for a private Internet Protocol address and port of a real device, according to the first aspect.

According to an fourteenth aspect of the invention there is provided a computer program for use in a computer for maintaining a NAT bind for a real device in a private network, according to the second aspect.

According to a fifteenth aspect of the invention there is provided a computer program for use in a computer for discovering NAT bind for a real device in a private network, according to the third and fourth aspects.

According to a sixteenth aspect of the invention there is provided a computer program for use in a computer for opening a NAT bind for a real device in a communications system, according to the fifth aspect.

Advantageously the above methods and apparatus avoid having to modify all gateways and other devices to either support STUN or send packets frequently, and can be used to maintain NAT binds when gateway or other device are on hold or otherwise not sending packets.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a schematic diagram showing the location of an IP faker A in relation to a NAT and a real device, during operation in accordance with a first embodiment of the invention;

FIG. 2 is a schematic diagram similar to FIG. 1, and additionally shows the flow of messaging that takes place during operation in accordance with the embodiment shown in FIG. 1;

FIG. 3 is a schematic diagram showing the flow of messaging that occurs between different network elements when the IP faker A is located in the signalling path, in accordance with a second embodiment of the invention;

FIG. 4 is a schematic diagram showing the flow of messaging that occurs between different network elements when the IP faker A is controlled by a Controller and is used to open and discover NAT bind for a real device, in accordance with a third embodiment of the invention; and

FIG. 5 is a message sequence chart following a specific format known in the art, and shows the flow of messaging that occurs for the third embodiment of the invention shown in FIG. 4.

### Detailed DESCRIPTION OF THE PREFERRED EMBODIMENTS

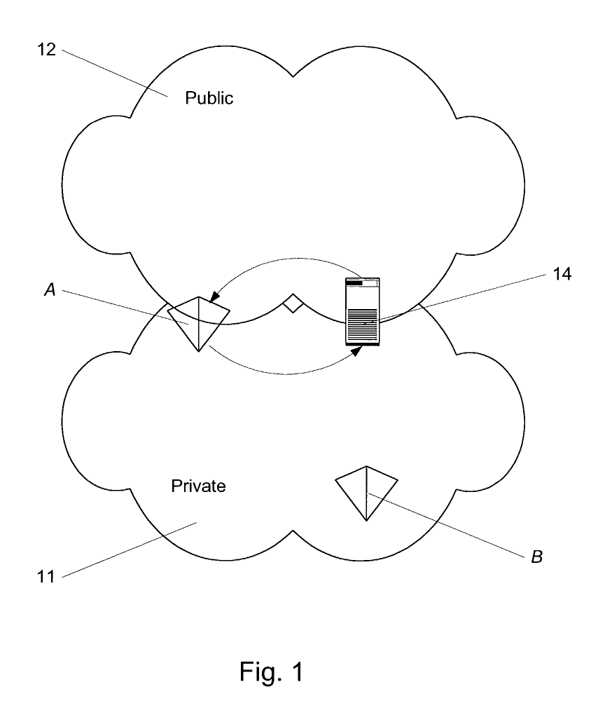

With reference to FIG. 1, an Internet Protocol faking device (IP faker) A is located on the boundary between the private network 11 containing a real device B and a public network 12. A NAT 14 connects these two networks. The IP faker A sends packets through the NAT 14, whereby the source fields of the packets have been edited to be the Internet Protocol (IP) address and port of the real device B. When the packets are received by the NAT 14 and their headers analysed, the NAT 14 is fooled into determining that the packets are being sent by the real device B, thereby allowing the IP faker A to open a NAT bind and maintain the NAT bind on behalf of the real device B.

The IP faker can be prompted by a Network Element to open or maintain a NAT bind, and for the purposes of this specification, the Network Element may include the real device, i.e. the real device may prompt the IP faker to open and/or maintain a NAT bind on its behalf.

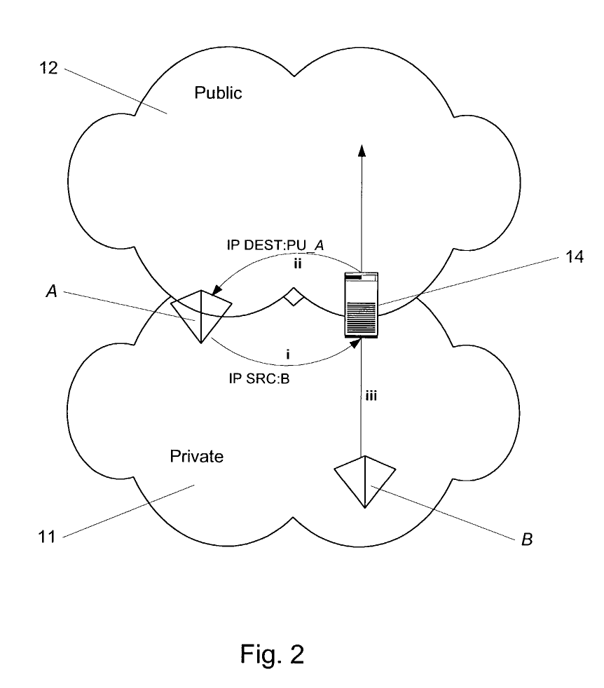

Preferred methods for creating, maintaining and discovering the NAT bind will now be described in more detail for a Cone NAT, with reference to FIG. 2. An IP faker A is located in parallel with a NAT 14, on the boundary between the private network 11 containing a real device B and a public network 12, with the NAT 14 connecting the two networks. The IP faker A generates data packets in which the headers of the data packets have the source fields edited to state the IP address and port of the real device B, i.e. IP SRC:B. The IP faker A sends the edited data packets to its public address PU-A, i.e. IP DEST:PU-A, via the NAT 14—i. The NAT 14, on receiving the data packets, analyses the IP headers and determines the data packets to have been sent by the real device B.

The NAT 14, tricked into thinking that the packets have been sent by the real device B, opens a NAT bind for the real device B. The NAT 14 changes the source fields in the IP and UDP or TCP headers of the data packets to be the public address and port for the real device B, and forwards the data packets to the public interface of the IP faker A, i.e. PU-A,—ii. The IP faker A is able to discover the NAT bind by analysing the source fields in the IP headers of the data packets received at its public interface.

When real device B subsequently starts sending packets through the NAT 14—iii to a different destination, the NAT 14 is unaware that they are coming from a different device to the IP faker A, so the same bind already created by the IP faker A is used. (Note that this is true only because the NAT is a cone NAT.)

The IP faker A is able to maintain the NAT bind by simply sending data packets through the NAT bind from its private interface to its public interface on a regular basis. The periods of time between the transmissions are set to be smaller than the timeout period of the NAT 14. Alternatively, once the NAT bind has been created, the IP faker A awaits receipt of a message from either the real device B or a controller which tells it that the real device B is on hold (or otherwise not sending packets frequently enough to maintain the bind) and to maintain the NAT bind. The IP faker A then sends out data packets through the NAT bind from its private to public interface in order to maintain the NAT bind.

By locating the IP faker A on the boundary of the private and public networks (i.e. in parallel with the NAT), the IP faker A is able to discover the NAT bind by sending data packets (with faked source fields) from its private to its public interface, and analysing the IP headers.

Advantageously, the IP faker A can either be:

a) in the signalling path between the controller and the real device B. It can then intercept the requests and replies for Session Description Protocol (SDP) information, and create the bind and discover the public address for the real device B at this stage. It then modifies the SDP to contain the correct public address. The IP faker A stops maintaining the bind when the connection is deleted.

b) controlled by the controller. When the controller sets up the real device B, it requests the IP faker A to open and discover a bind through the NAT 14. The controller instructs the IP faker A to stop maintaining the bind when the connection has been deleted on the real device B.

c) in the private network of the real device. The IP faker opens a NAT bind by altering the source fields in the IP header of a data packet to place the IP address and port of the real device, and sends the altered data packet from its private interface through the NAT.

A detailed description of the use of the IP faker in the two positions a) and b) described above now follows.

### EXAMPLE (a)

### Device in the Signalling Path

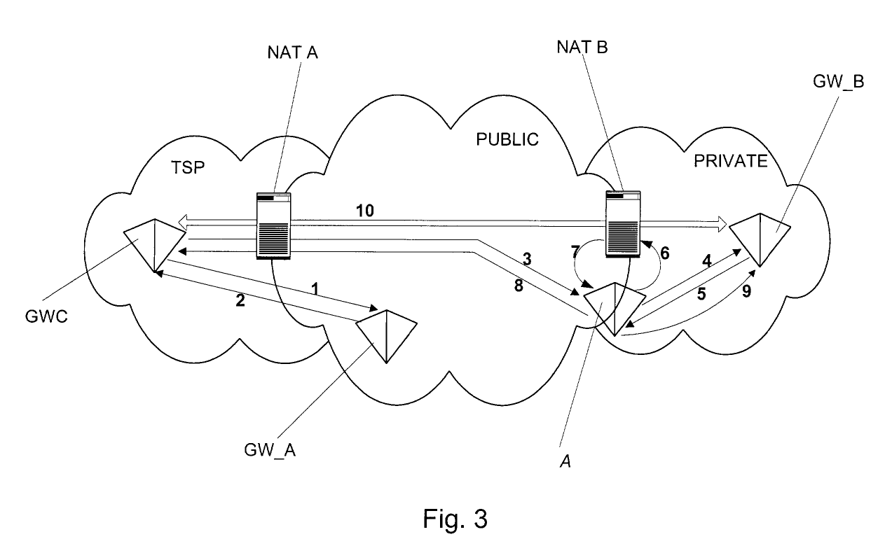

With reference to FIG. 3, an IP faker A is located on the boundary of a private network and public network, and Gateways GW_A and GW_B are located, respectively, in the public and private networks. A Gateway Controller GWC is located in a Telephony Service Provider's (TSP's) network. A NAT A lies on the boundary of the private and public networks, and a NAT B lies on the boundary of the public and TSP networks. The IP faker A lies in parallel to the NAT B, and has a public and a private IP address in order to provide a signalling path to the Gateway GW_B located in the private network. The location of the IP faker A enables it to intercept all the messages between the Gateway Controller GWC and the Gateway GW_B. Note that it is presumed that the Gateway GW_A communicates with the Gateway Controller GWC, and has a public address where it receives media packets.

The Gateway GW_A initiates a call to the Gateway GW_B, by notifying the Gateway Controller GWC which sends a create connection message (CRCX) to the Gateway GW_A-1. The Controller GWC then receives the Session Description Protocol (SDP) of the Gateway GW_A-2, and sends a create connection message (CRCX) to the other Gateway GW_B with the SDP of the Gateway GW_A-3. All signalling to the Gateway GW_B is intercepted by the IP faker A which forwards the CRCX to the Gateway GW_B-4. In response, the Gateway GW_B replies to the IP faker A with its own SDP-5.

The IP faker A analyses the SDP received from the Gateway GW_B and retrieves the private IP address of the Gateway GW_B. It then uses this information to create a discovery data packet having a source IP address and port that are the private IP address and port of the Gateway GW_B, and a destination IP address and port that is its own public IP address and port. The IP faker A sends the discovery data packet over the private network to open a bind in the NAT B-6. The NAT B changes the source IP address and port (i.e. the private IP address and port of the Gateway GW_B) to a public IP address and port, and forwards the message to the public interface of the IP faker A-7. The received discovery data packet is analysed by the IP faker A which extracts the source IP address assigned by the NAT B (PU-NB), puts it in the SDP received from the Gateway GW_B, and sends it back to the Controller GWC-8.

The Controller GWC receives the SDP from the IP faker A, and forwards it to the Gateway GW_A. The Gateway GW_A can now begin sending data packets to the PU-NB IP address, and which are then forwarded by the NAT B to the private IP address of the Gateway GW_B (GB). Thus the data packets will reach the Gateway GW_B.

### EXAMPLE (b)

### Device Controlled by a Controller

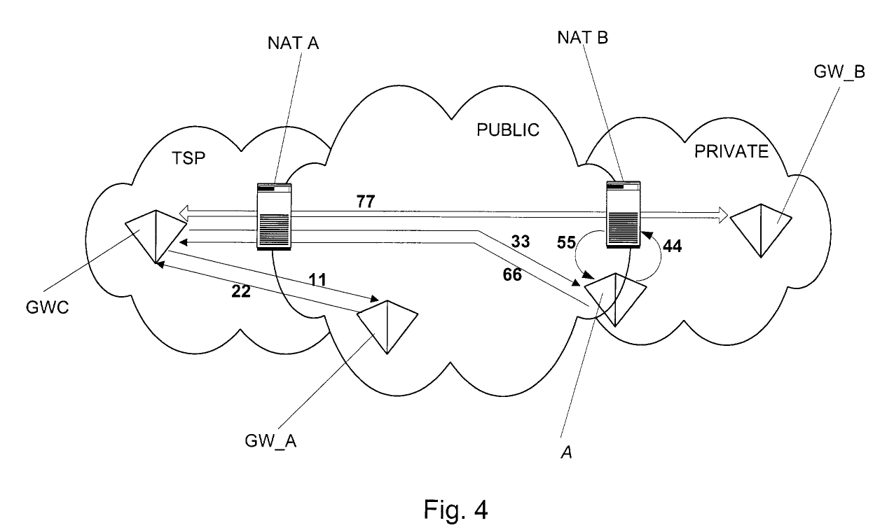

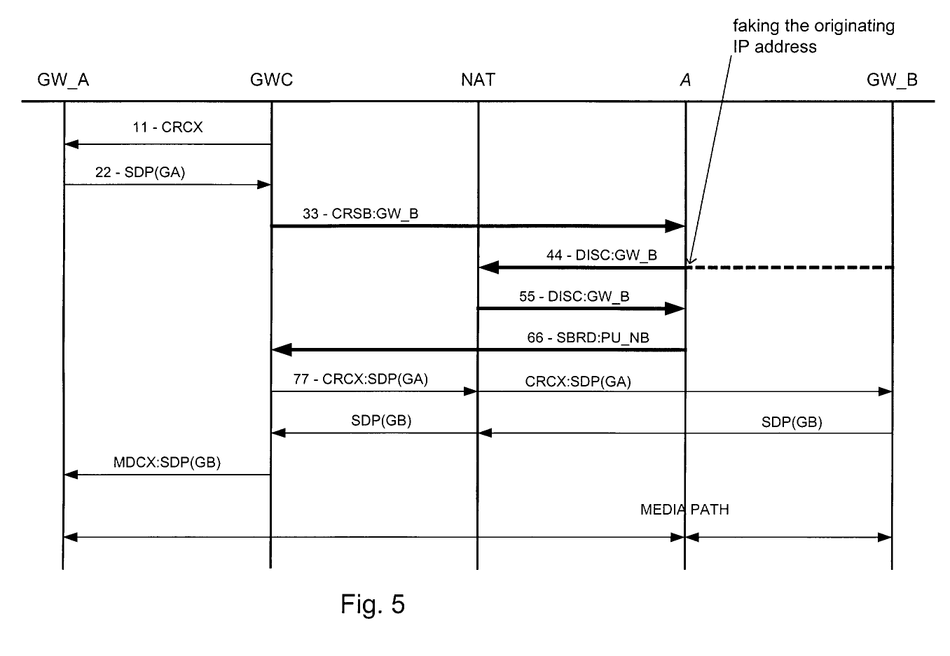

With reference to FIGS. 4 and 5, the topology illustrated is similar to that shown in FIG. 3 where the IP faker is in the signalling path, and once again the IP faker A has a public and a private IP address. However, in this case, the Controller GWC is aware of the existence of the IP faker A and its function. The Controller GWC makes use of the IP faker A in order to create a bind in the NAT B and be able to communicate with the Gateway GW_B. In this scenario, it is assumed that the Gateway GW_A is controlled by the Controller GWC and provides a SDP with a public address that can be used to send data packets.

The Gateway GW_A initiates a call to the Gateway GW_B by notifying the Controller GWC that controls the Gateway GW_B. The Controller GWC sends a create connection message (CRCX) to the Gateway GW_A-11. In response, the Gateway GW_A sends a SDP with its public IP address to the Controller GWC-22. As the Controller GWC is aware of the existence and function of the IP faker A, the Controller GWC knows that it needs to send a message to the IP faker A to open a bind in the NAT B in order to send signalling to the Gateway GW_B. The Controller GWC, therefore, sends a Create Signalling Bind request (CSBR) to the IP faker A to open a bind for the Gateway GW_B -33. When the IP faker A receives the Create Signalling Bind request CSBR:GW_B, it retrieves the private IP address and port of the Gateway GW_B by looking it up in its database. The IP faker A then uses this information to create a discovery packet (DISC) having a source IP address and port that are the private IP address and port of the Gateway GW_B (PR-GB), and a destination IP address and port that is its own public IP address and port (PU-DA). The IP faker A sends the discovery packet DISC:GW_B over the private network to open a bind in the NAT B-44. The NAT B receives the discovery packet DISC:GW_B, which tricks the NAT B into creating a bind for the Gateway GW_B. The NAT B changes the source IP address and port (i.e. the private signalling IP address and port of the Gateway GW_B) to a public IP address and port allocated for the Gateway GW_B (PU-NB), and forwards the message to the public interface of the IP faker A-55. The received discovery packet DISC:GW_B is analysed by the IP faker A which extracts the source IP address and port assigned by the NAT B (PU-NB), and sends it to the Controller GWC in Signalling Bind Ready message SBRD:PU_NB-66. The Controller GWC now has an open signalling path to the Gateway GW_B, and extracts the public IP address and port assigned to the Gateway GW_B (PU-NB). The Controller GWC uses this IP address and port to start sending signalling packets CRCX:SDP(GA) to the Gateway GW_B-77.

The procedure can be repeated to create a bind in the NAT B for data packets. Although pseudo-MGCP has been used to show messaging between the Gateway Controllers and the Gateways in the above-described examples, any other suitable Device Control Protocol, such as H.248 (MEGACO), NCS, or ASPEN could be used instead. In addition, SIP, H.323, or other similar Session Description Protocol (SDP) exchange protocols that are not DCPs, and that do not always fit into the Gateway/Gateway Controller architecture, could be used instead

Advantageously, the methods described herein may be implemented in software, hardware, or a mixture of both.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

Although the invention has been shown and described with respect to a best mode embodiment thereof, it should be understood by those skilled in the art that the foregoing and various other changes, omissions and additions in the form and detail thereof may be made therein without departing from the scope of the invention as claimed.

We claim:

1. A method of opening a NAT bind for the private Internet Protocol address and port of a real device, said real device having a private Internet Protocol address and port, said method comprising:
placing the private Internet Protocol address and port of the real device in source fields of an Internet Protocol header of a data packet of a different device; and
sending said data packet through a NAT.

2. A method according to claim 1, wherein the data packets are from the group of: STUN, MGCP, H.248 (MEGACO), NCS, ASPEN, SIP and H.323.

3. A method of maintaining a NAT bind for a real device in a private network, said real device having a private Internet Protocol address and port, said method comprising at predetermined time intervals:
editing a data packet having an Internet Protocol header comprising source fields by altering its source fields to comprise the private Internet Protocol address and port of a real device; and
sending the edited data packets from a private interface of an Internet Protocol faker through a NAT,
wherein said time intervals are predetermined to be smaller than the timeout period set for the NAT.

4. A method according to claim 3, wherein the data packets are from the group of: STUN, MGCP, H.248 (MEGACO), NCS, ASPEN, SIP and H.323.

5. A method of discovering NAT bind for a real device in a private network, comprising:
sending a data packet with faked source fields in its IP headers from a private interface to a public interface of an Internet Protocol faker through a NAT; and
analysing the source fields of the data packet received at the public interface of the Internet Protocol faker from the NAT to determine the NAT bind.

6. A method according to claim 5, wherein the data packets are from the group of: STUN, MGCP, H.248 (MEGACO), NCS, ASPEN, SIP and H.323.

7. A method according to claim 5, wherein sending the data packet with faked source fields in its Internet Protocol header from the private interface to the public interface of the Internet Protocol faker through the NAT, comprises:
editing the data packet by altering its source fields to comprise the private Internet Protocol address and port of the real device;
sending the data packet edited by the Internet Protocol faker from its private interface to its public interface through the NAT;
receiving the edited data packet at the NAT from the Internet Protocol faker;
reading the source fields of the edited data packet;
opening a NAT bind for the private Internet Protocol address and port of the real device; and
forwarding the data packet to the public interface of the Internet Protocol faker.

8. A method according to claim 5, wherein opening the NAT bind for the private Internet Protocol address and port of the real device comprises:
replacing the private Internet Protocol address and port of the real device contained in the source fields of the data packet with a public address and port assigned to the real device.

9. A method according to claim 5, wherein analysing the source fields of the data packet received at the public interface of the Internet Protocol faker comprises:
reading the source fields of the forwarded data packet; and
extracting the public Internet Protocol address and port for the real device.

10. A method of discovering a Cone NAT bind for a real device in a private network said real device having a private Internet Protocol address and port, said method comprising:
editing a data packet having an Internet Protocol header comprising source fields by altering the source fields to comprise the private Internet Protocol address and port of the real device;
sending the edited data packet from a private interface to a public interface of the Internet Protocol faker through a Cone NAT;
receiving the edited data packet at the NAT from the Internet Protocol faker;
reading the source fields of the edited data packet;
opening a NAT bind for the private Internet Protocol address and port of the real device;
forwarding the data packet to the public interface of the Internet Protocol faker;
reading the source fields of the data packet received at the public interface of the Internet Protocol faker; and
extracting a public Internet Protocol address and port assigned to the real device to determine the NAT bind.

11. A method according to claim 10, wherein the data packets are from the group of: STUN, MGCP, H.248 (MEGACO), NCS, ASPEN, SIP and H.323.

12. A method according to claim 10, wherein opening the NAT bind for the Internet Protocol address and port of the real device comprises:
replacing the private Internet Protocol address and port of the real device contained in the source fields of the data packet with the public address and port assigned to the real device.

13. A method of opening a NAT bind for a real device in a communications system comprising a signalling device and an Internet Protocol faker locatable in a signalling path of the signalling device and in parallel with a Cone NAT, said method comprising:
receiving a communication initiation message from an external device;
allocating the signalling device to handle the message;
editing a data packet by altering its source fields to comprise a private Internet Protocol address and port of the signalling device;
sending the edited data packet from a private to a public interface of the Internet Protocol faker, through the Cone NAT;
analysing the source fields of the data packet received at the public interface of the Internet Protocol faker to determine a public Internet Protocol address of the Cone NAT bind; and
sending a redirection message with the public Internet Protocol address of the NAT bind to the external device.

14. A method according to claim 13, wherein the data packets are from the group of: STUN, MGCP, H.248 (MEGACO), NCS, ASPEN, SIP and H.323.

15. An Internet Protocol faker having a private interface and a public interface, and operable to:
edit a data packet by altering its source fields to comprise a private Internet Protocol address and port of a real device in a private network that said Internet Protocol faker is impersonating; and
send the edited data packet from its private interface to its public interface through a Cone NAT.

16. An Internet Protocol faker according to claim 15, further operable to analyse the source fields of the data packet received at its public interface from the NAT to determine the NAT bind of the real device.

17. A communications system comprising: an Internet Protocol faker locatable on the boundary of a private and a public network and in parallel with a Cone NAT, said Internet Protocol faker having a private interface and a public interface, and operable to:
edit a data packet by altering its source fields to comprise a private Internet Protocol address and port of a real device in a private network that said Internet Protocol faker is impersonating; and
send the edited data packet from its private interface to its public interface through the Cone NAT.

18. A communications system according to claim 17, wherein said Internet Protocol faker is further operable to analyse the source fields of the data packet received at its public interface from the NAT to determine the NAT bind of the real device.

19. An Internet Protocol faker having a private and a public interface, and operable to:
receive a command to establish a NAT bind for a real device from a Network Element;
edit a data packet by altering its source fields to comprise a private Internet Protocol address and port of the real device;
send the edited data packet from its private interface to its public interface through a Cone NAT, said Cone NAT creating a NAT bind for the data packet;
analyse the source fields of the data packet received at its public interface from the NAT to determine a public Internet Protocol address of the NAT bind; and
send a reply to the Network Element with the public Internet Protocol Address of the NAT bind.

20. An Internet Protocol faker according to claim 19, wherein the Network Element comprises the real device.

21. An Internet Protocol faker having a private and a public interface, and operable to:
receive a communication initiation message from an external device;
allocate a signalling device to handle the message;
edit a data packet by altering its source fields to comprise a private Internet Protocol address and port of the signalling device;
send the edited data packet from its private interface to its public interface through a Cone NAT, said NAT creating a Cone NAT bind for the data packet;
analyse the source fields of the data packet received at its public interface from the Cone NAT to determine a public Internet Protocol address and port of the Cone NAT bind; and
send a redirection message with the public Internet Protocol address of the Cone NAT bind to the external device.

22. An Internet Protocol faker according to claim 21, wherein the Internet Protocol faker is operable to open a NAT bind for at least one of a signalling path and a media flow.

23. A communications system comprising: a signalling device, and an Internet Protocol faker locatable in a signalling path of the signalling device and in parallel with a NAT, said NAT operable to create a NAT bind for a data packet, said Internet Protocol faker having a private and a public interface and operable to:
receive a communication initiation message;
allocate the signalling device to handle the message;
edit a data packet by altering its source fields to comprise a private Internet Protocol address and port of the signalling device;
send the edited data packet from its private interface to its public interface through the NAT;
analyse the source fields of the data packet received at its public interface from the NAT to determine a public Internet Protocol address of the NAT bind; and
send a redirection message with the public Internet Protocol address of the NAT bind.

24. A communications system according to claim 23, wherein the Internet Protocol faker is operable to open a NAT bind for at least one of a signalling path and a media flow.

25. An Internet Protocol faker having a private interface and operable to:
edit a data packet by altering its source fields to comprise the Internet Protocol address and port of a real device in a private network that said Internet Protocol faker is impersonating; and
send the edited data packet from its private interface through a NAT.

26. A communications system comprising: an Internet Protocol faker locatable in a private network, said Internet Protocol faker having a private interface, and operable to:
edit a data packet by altering its source fields to comprise the Internet Protocol address and port of a real device in a private network that said Internet Protocol faker is impersonating; and
send the edited data packet from its private interface through a NAT.

27. A communications system according to claim 26, wherein the IP faker has a public interface and is further operable to:
send the edited data packet from its private interface to its public interface through the NAT; and
analyse the source fields of the data packet received at its public interface from the NAT to determine the NAT bind of the real device.

28. A computer program for use in a computer for opening a NAT bind for a private Internet Protocol address and port of a real device, according to the method of claim 1.

29. A computer program for use in a computer for maintaining a NAT bind for a real device in a private network, according to the method of claim 3.

30. A computer program for use in a computer for discovering NAT bind for a real device in a private network, according to the method of claim 5.

31. A computer program for use in a computer for discovering NAT bind for a real device in a private network, according to the method of claim 10.

32. A computer program for use in a computer for opening a NAT bind for a real device in a communications system, according to the method of claim 13.
